(19) United States
(12) Patent Application Publication
(10) Pub. No.: US 2018/0211476 A1
(43) Pub. Date: Jul. 26, 2018

(54) GAME PROVISIONING WITH ON-LINE AND OFF-LINE CORRESPONDENCE

(71) Applicant: Jong Won JIN, Seoul (KR)

(72) Inventor: Jong Won JIN, Seoul (KR)

(21) Appl. No.: 15/412,649

(22) Filed: Jan. 23, 2017

(51) Int. Cl. G07F 17/32

(52) U.S. Cl. CPC G07F 17/3211; G07F 17/3241; G07F 17/3227

(57) ABSTRACT

A method for providing a game is disclosed, wherein the method includes receiving a first game participation request including off-line avatar player selection from an on-line player device, wherein the off-line avatar player is preset in an off-line game region and plays the game, wherein the on-line player device is of an on-line player present in on-line game region, wherein allocating a first authority to the on-line player device, wherein the first authority allows the on-line player device to receive game-related information from the off-line avatar player device and to send gaming-related commands including a betting request to the off-line avatar player device; and allocating an access authority to the on-line player device and the off-line avatar player device to access an on-line platform to facilitate communication between the on-line player device and the off-line avatar player device.

### BACKGROUND

### Field of the Present Disclosure

The present disclosure relates to game provisioning with on-line and off-line correspondence.

### Discussion of Related Art

The casino is an entertainment venue with various entertainment facilities, and is now transforming into a resort that combines tourism and entertainment. The casino industry is also shifting from the negative image of the past to positive images such as foreign currency acquisition, tourism revenue generation, regional development and regional economic revitalization.

The casino includes a game table on which players play the game with chips such as baccarat, roulette, etc., a money changing space to exchange chips and money, and a settlement room to settle cash received through the game table or money changing room. A dealer is arranged in the game table for the proceedings of the game, and cashiers are assigned in the money changing or settlement room to handle currency exchange and settlement transactions respectively.

As many countries have begun to legalize casinos, casinos have begun to emerge as key facilities for recreation and entertainment. However, there are many players who cannot participate in the game due to limitations in a number of seats available in the casino table. U.S. design Pat. No. D442643 discloses a casino table.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter.

Accordingly, there is a need to provide a method for provisioning a game between on-line and off-line regions so that players who, otherwise, cannot participate in the game due to space constraints can participate in the game through player device thereof. The present disclosure is to provide game provisioning with on-line and off-line correspondence.

In one aspect, there is provided one or more non-transitory, computer-readable media having instructions stored thereon, the instructions when executed by one or more processors cause the one or more processors to perform operations of a method for providing a game, wherein the operations includes: receiving a first game participation request including off-line avatar player selection from an on-line player device, wherein the off-line avatar player is preset in an off-line game region and plays the game, wherein the on-line player device is of an on-line player who is not present in the off-line game region but in on-line game region and plays the game, wherein the off-line avatar player has an off-line avatar player device; establishing matching between the on-line player and the off-line avatar player at least partially based on the first game participation request; in a response to the established matching between the on-line player and the off-line avatar player, allocating a first authority to the on-line player device, wherein the first authority allows the on-line player device to receive game-related information from the off-line avatar player device and to send gaming-related commands including a betting request to the off-line avatar player device; in a response to the established matching between the on-line player and the off-line avatar player, allocating an access authority to the on-line player device and the off-line avatar player device to access an on-line platform to facilitate communication between the on-line player device and the off-line avatar player device; receiving a second game participation request including at least one of on-line player selection and on-line platform selection from an on-line betting participator device, wherein the on-line betting participator device is of an on-line betting participator who is not present in the off-line game region but in on-line game region and make a betting action for the game involving the on-line player and off-line avatar player; and allocating a second authority to the on-line betting participator device at least partially based on the second game participation request, wherein the second authority includes authorities to allow the on-line betting participator device to access the on-line platform corresponding to the on-line platform selection, and to make a betting action for the game involving the on-line player and off-line avatar player.

In one implementation of the one or more non-transitory, computer-readable media, the operations further includes: generating game-related information including at least one of game type, minimum betting amount, information about at least one selectable off-line avatar player, and information about at least one on-line selectable platform, for the game held in the off-line region.

In one implementation of the one or more non-transitory, computer-readable media, the operations further includes: generating graphical representation of the off-line avatar player involving the game in the off-line region, wherein the off-line avatar player selection comprises selection of the graphically represented off-line avatar player from the on-line player device.

In one implementation of the one or more non-transitory, computer-readable media, the operations further includes: determining whether the on-line player meets a predetermined condition, wherein the operation of establishing matching between the on-line player and the off-line avatar player includes: upon determination that the on-line player meets the predetermined condition, establishing matching between the on-line player and the off-line avatar player; and upon determination that the on-line player does meet the predetermined condition, generating billing information, wherein when the on-line player has paid for the billing, it is determined that the on-line player meets the predetermined condition.

In one implementation of the one or more non-transitory, computer-readable media, the operations further includes: allocating a third authority to the on-line player device at least partially based on the second game participation request, wherein the third authority allow transmissions of gaming-related commands from the on-line betting participator device to the off-line avatar player device.

In one implementation of the one or more non-transitory, computer-readable media, the first authority is allocated based on at least one of a predetermined time, a predetermined number of plays of the game, and a predetermined total betting amount.

In one implementation of the one or more non-transitory, computer-readable media, the first authority is further based on on-line player information about the on-line player, wherein the on-line player information includes at least one of player identification information, winning rate information, point information, membership type information, investment amount information and settlement history information.

In one implementation of the one or more non-transitory, computer-readable media, the on-line platform is configured to facilitate communication of at least one of video information, audio information and text information, wherein the on-line platform is embodied as at least one of on-line bulletin platform, on-line chatting platform, on-line messenger platform and on-line voice platform.

In one implementation of the one or more non-transitory, computer-readable media, wherein the game-related information is acquired by the off-line avatar player device, wherein the game-related information includes at least one of video information and audio information for the game held the off-line region.

In one implementation of the one or more non-transitory, computer-readable media, the game held the off-line region includes at least one of roulette, blackjack or baccarat.

In one implementation of the one or more non-transitory, computer-readable media, the information about at least one selectable off-line avatar player includes at least one of gaming available time for at least one off-line avatar player, fee information for using off-line avatar players, evaluation information about off-line avatar players, and/or wining rate information about off-line avatar players, wherein the information about the on-line platform includes at least one of wining rate information for the game involving the on-line player and the off-line avatar player, gaming-proceeding summary information about the game, and member information about on-line betting participators for the game.

In another aspect, there is provided a server for providing a game, wherein the server are communicatively coupled to an on-line player device, an off-line avatar player device, and an on-line betting participator device, wherein the on-line player device, the off-line avatar player device, and the on-line betting participator device are of an on-line player, an off-line avatar player, and an on-line betting participator respectively, wherein the off-line avatar player is preset in an off-line game region and plays the game, wherein the on-line player is not present in the off-line game region but in on-line game region and plays the game, wherein the on-line betting participator is not present in the off-line game region but in on-line game region and makes a betting action for the game involving the on-line player and off-line avatar player, wherein the server comprises: means for receiving a first game participation request including off-line avatar player selection from the on-line player device; means for establishing matching between the on-line player and the off-line avatar player at least partially based on the first game participation request; in a response to the established matching between the on-line player and the off-line avatar player, means for allocating a first authority to the on-line player device, wherein the first authority allows the on-line player device to receive game-related information from the off-line avatar player device and to send gaming-related commands including a betting request to the off-line avatar player device; in a response to the established matching between the on-line player and the off-line avatar player, means for allocating an access authority to the on-line player device and the off-line avatar player device to access an on-line platform to facilitate communication between the on-line player device and the off-line avatar player device; means for receiving a second game participation request including at least one of on-line player selection and on-line platform selection from the on-line betting participator device; and means for allocating a second authority to the on-line betting participator device at least partially based on the second game participation request, wherein the second authority includes authorities to allow the on-line betting participator device to access the on-line platform corresponding to the on-line platform selection, and to make a betting action for the game involving the on-line player and off-line avatar player.

In still another aspect, there is provided a system for providing a game, system including a server, an on-line player device, and an off-line avatar player device, wherein the server and devices are communicatively coupled to each other, wherein the on-line player device, and the off-line avatar player device are of an on-line player, and an off-line avatar player, wherein the off-line avatar player is preset in an off-line game region and plays the game, wherein the on-line player is not present in the off-line game region but in on-line game region and plays the game, wherein the server comprises: means for receiving a first game participation request including off-line avatar player selection from the on-line player device; means for establishing matching between the on-line player and the off-line avatar player at least partially based on the first game participation request; in a response to the established matching between the on-line player and the off-line avatar player, means for allocating a first authority to the on-line player device, wherein the first authority allows the on-line player device to receive game-related information from the off-line avatar player device and to send gaming-related commands including a betting request to the off-line avatar player device; and in a response to the established matching between the on-line player and the off-line avatar player, means for allocating an access authority to the on-line player device and the off-line avatar player device to access an on-line platform to facilitate communication between the on-line player device and the off-line avatar player device.

In one implementation of the system, the system further include an on-line betting participator device, wherein the on-line betting participator device is of an on-line betting participator, wherein the on-line betting participator is not present in the off-line game region but in on-line game region and makes a betting action for the game involving the on-line player and off-line avatar player, wherein the server further comprises: means for receiving a second game participation request including at least one of on-line player selection and on-line platform selection from the on-line betting participator device; and

means for allocating a second authority to the on-line betting participator device at least partially based on the second game participation request, wherein the second authority includes authorities to allow the on-line betting participator device to access the on-line platform corresponding to the on-line platform selection, and to make a betting action for the game involving the on-line player and off-line avatar player.

In one implementation of the system, the server further comprises: means for generating game-related information including at least one of game type, minimum betting amount, information about at least one selectable off-line avatar player, and information about at least one on-line selectable platform, for the game held in the off-line region.

In one implementation of the system, the server further comprises: means for determining whether the on-line player meets a predetermined condition, wherein the means for establishing matching between the on-line player and the off-line avatar player includes: upon determination that the on-line player meets the predetermined condition, means for establishing matching between the on-line player and the off-line avatar player; and upon determination that the on-line player does meet the predetermined condition, means for generating billing information, wherein when the on-line player has paid for the billing, it is determined that the on-line player meets the predetermined condition.

In one implementation of the system, the server further comprises: means for allocating a third authority to the on-line player device at least partially based on the second game participation request, wherein the third authority allow transmissions of gaming-related commands from the on-line betting participator device to the off-line avatar player device.

In one implementation of the system, the first authority is allocated based on at least one of a predetermined time, a predetermined number of plays of the game, and a predetermined total betting amount.

In one implementation of the system, the first authority is further based on on-line player information about the on-line player, wherein the on-line player information includes at least one of player identification information, winning rate information, point information, membership type information, investment amount information and settlement history information.

In one implementation of the system, the on-line platform is configured to facilitate communication of at least one of video information, audio information and text information, wherein the on-line platform is embodied as at least one of on-line bulletin platform, on-line chatting platform, on-line messenger platform and on-line voice platform.

In one implementation of the system, the on-line player device and/or the off-line avatar player is embodied as a VR (virtual reality) device and/or 3D (three-dimensional) device.

### BRIEF DESCRIPTION OF THE DRAWINGS

The accompanying drawings, which are incorporated in and form a part of this specification and in which like numerals depict like elements, illustrate embodiments of the present disclosure and, together with the description, serve to explain the principles of the disclosure.

FIG. 1 is a block diagram illustrating a system for providing a game in accordance with embodiments of the present disclosure.

FIG. 2 is a flow chart of a method for providing a game in accordance with embodiments of the present disclosure.

FIG. 3 is another flow chart of a method for providing a casino game in accordance with embodiments of the present disclosure.

FIG. 4 is a view of an example of a use interface of the player device during the gaming using the method for providing a game in accordance with embodiments of the present disclosure.

FIG. 5 is a conceptional view for describing a method for providing a game in accordance with embodiments of the present disclosure.

FIG. 6 is a block diagram of a computer executing a computer program configured to execute a method for providing a game in accordance with embodiments of the present disclosure.

FIG. 7 illustrates a schematic block diagram of an exemplary computing environment operable to perform a method for providing a game in accordance with the present disclosure.

### DETAILED DESCRIPTIONS

Examples of various embodiments are illustrated and described further below. It will be understood that the description herein is not intended to limit the claims to the specific embodiments described. On the contrary, it is intended to cover alternatives, modifications, and equivalents as may be included within the spirit and scope of the present disclosure as defined by the appended claims.

For simplicity and clarity of illustration, elements in the figures are not necessarily drawn to scale. The same reference numbers in different figures denote the same or similar elements, and as such perform similar functionality. Also, descriptions and details of well-known steps and elements are omitted for simplicity of the description. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

It will be understood that, although the terms “first”, “second”, “third”, and so on may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

It will be understood that when an element or layer is referred to as being “connected to”, or “coupled to” another element or layer, it can be directly on, connected to, or coupled to the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments only and is not intended to be limiting of the present disclosure. As used herein, the singular forms “a” and “an” are intended to include the plural forms as well, unless the context clearly indicates otherwise. It will be further understood that the terms “comprises”, “comprising”, “includes”, and “including” when used in this specification, specify the presence of the stated features, integers, operations, elements, and/or components, but do not preclude the presence or addition of one or more other features, integers, operations, elements, components, and/or portions thereof. As used herein, the term “and/or” includes any and all combinations of one or more of the associated listed items. Expression such as “at least one of” when preceding a list of elements may modify the entire list of elements and may not modify the individual elements of the list.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In the following description, numerous specific details are set forth in order to provide a thorough understanding of the present disclosure. The present disclosure may be practiced without some or all of these specific details. In other instances, well-known process structures and/or processes have not been described in detail in order not to unnecessarily obscure the present disclosure.

As used herein, the term “substantially,” “about,” and similar terms are used as terms of approximation and not as terms of degree, and are intended to account for the inherent deviations in measured or calculated values that would be recognized by those of ordinary skill in the art. Further, the use of “may” when describing embodiments of the present disclosure refers to “one or more embodiments of the present disclosure.”

As used herein, a term “off-line avatar player” may refer to a player present in an off-line region who plays an off-line game using a method for providing a game in accordance with embodiments of the present disclosure. As used herein, a term “on-line player” may refer to a player present not in an off-line region but in on-line region who plays the off-line game via off-line avatar player using a method for providing a game in accordance with embodiments of the present disclosure. As used herein, a term “on-line betting participator” may refer to a person present not in an off-line region but in on-line region who participates in the betting executed by the on-line player.

In accordance with the present disclosure, an on-line player 1 and on-line betting participator 2 are allocated with different authorities in accordance with embodiments of the present disclosure. For example, in accordance with embodiments of the present disclosure, the on-line player 1 may be allocated with an authority to send gaming-related commands including a betting request to the off-line avatar player 3 via the on-line player device 10. In accordance with embodiments of the present disclosure, the off-line avatar player 3 may receive the gaming-related commands and execute the game based on the gaming-related commands in an off-line region. In accordance with embodiments of the present disclosure, the on-line betting participator may be allowed to make a betting action for the game involving the off-line avatar player 3 and the on-line player 1. For example, the on-line betting participator 2 may be allowed to make a betting action for the game when the betting of the on-line betting participator 2 matches the betting from the on-line player 1.

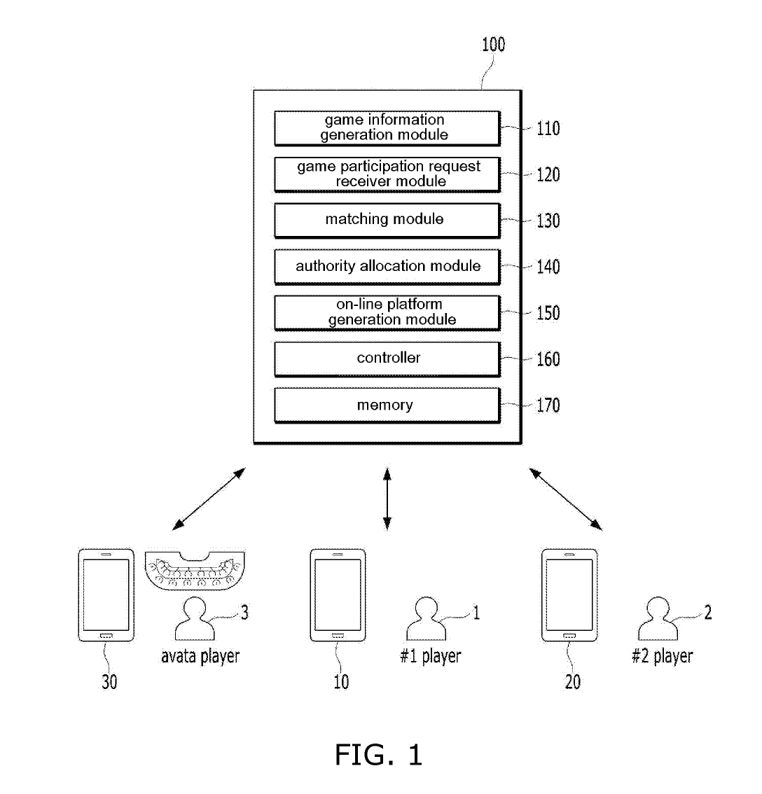

Hereinafter, a reference will be made to FIG. 1 in details. FIG. 1 is a block diagram illustrating a system for providing a game in accordance with embodiments of the present disclosure.

Referring to FIG. 1, a system for providing a game in accordance with embodiments of the present disclosure may include a server 100, an on-line player device 10 and an off-line avatar player device 30. Furthermore, the system may include an on-line betting participator device 20.

In accordance with embodiments of the present disclosure, the on-line player device 10 may receive a first game participation request including off-line avatar player selection from the on-line player. Furthermore, the on-line player device 10 may receive game-related information at least partially based on the first game participation request from the off-line avatar player, and may send gaming-related commands including a betting request to the off-line avatar player.

In accordance with embodiments of the present disclosure, the game-related information received from the off-line avatar player 3 may include at least one of video information and audio information about at least one game held in an off-line region.

In accordance with embodiments of the present disclosure, the on-line player device 10 may include an output module to output the game-related information received from the off-line avatar player 3 as described above. This output module may include, for example, at least one of a video output module and audio output module. However, the present disclosure is not limited thereto. In accordance with embodiments of the present disclosure, the on-line player 1 may check the game-related information received from the off-line avatar player 3.

In accordance with embodiments of the present disclosure, the off-line avatar player device 30 may obtain individual game-related information. For example, the off-line avatar player device 30 may include an imaging module such that video information and audio information about gaming proceeding held in an off-line region. Furthermore, the off-line avatar player device 30 may receive the gaming-related commands including a betting request from the on-line player device 10. These gaming-related commands may be embodied as at least one of video information, audio information and text information. In accordance with embodiments of the present disclosure, the off-line avatar player device 30 may include an output module such that the off-line avatar player 3 easily check the gaming-related commands received from the on-line player device 10. For example, when the gaming-related command has a form of a sound, for example “betting”, the off-line avatar player device 30 may output the sound, for example “betting” via the audio output module, for example, a loudspeaker.

In accordance with embodiments of the present disclosure, the on-line player 1 may monitor on-line the game held in an off-line region, for example, casino game and send the gaming-related commands to the off-line avatar player 3.

In accordance with embodiments of the present disclosure, the on-line betting participator device 20 may receive a second game participation request including on-line platform selection from the on-line betting participator. In accordance with embodiments of the present disclosure, the server 100 may assign, least partially based the second game participation request, a second authority to the second player to allow access to the on-line platform corresponding to the on-line platform selection and betting action for the game involving at least one of the off-line avatar player and the on-line player.

As used herein, the on-line player device 10, on-line betting participator device 20 and off-line avatar player device 30 may be collectively referred to as the player device 10, 20 and 30.

In accordance with embodiments of the present disclosure, the player devices 10, 20 and 30 each may include a wireless mobile device such as a cellular phone, a tablet, a notebook, PDA, etc. However, the present disclosure is not limited thereto. Furthermore, the player devices 10, 20 and 30 each may contains a computer-readable medium having a computer program to execute operation of the method for providing a game in accordance with embodiments of the present disclosure.

For example, the player devices 10, 20 and 30 each may include a user terminal (UE), a PC capable of wireless communication, a mobile cellular phone, a kiosk, a tablet, a netbook, a palmtop, a cellular phone, a cellular terminal, a subscriber unit, a subscriber station, a wireless terminal, an access terminal, a user agent, a cellular telephone, a wireless telephone, a session initiation protocol (SIP) phone, a wireless local loop (WLL) station, and the like. However, the present disclosure is not limited thereto.

Furthermore, the player devices 10, 20, and 30 each may be referred to as any device capable of using a wired connection mechanism such as a wired fax, a PC with a wired modem, a wired telephone, a terminal capable of wired communication, etc. However, the present disclosure is not limited thereto.

In accordance with embodiments of the present disclosure, the player devices 10, 20, and 30 each may include one or more display units, one or more processors, and a memory configured to store instructions executable by the one or more processors.

Furthermore, in accordance with embodiments of the present disclosure, the player device 10, 20 and 30 each may be employed as, for example, a VR device and/or 3D device. In addition, each of the player devices 10, 20 and 30 may be embodied as, for example, a head mounted display (HMD), an imaging device, a sensor equipment, a wearable computer equipment, etc.

As shown in FIG. 1, the server 100 may be connected to at least one of the player devices 10, 20 and 30 through a network. In accordance with embodiments of the present disclosure, the server 100 may be configured to communicate various information with the player device 10, 20 and 30 and/or another server to facilitate a method for providing a game in accordance with embodiments of the present disclosure.

In accordance with embodiments of the present disclosure, each of the server 100 and the player devices 10, 20 and 30 may include a network module. The network module may include wired/wireless Internet modules for network access. Wireless Internet techniques may include WLAN (wireless LAN: Wi-Fi), Wibro (wireless broadband), Wimax (World Interoperability for Microwave Access), HSDPA (High Speed Downlink Packet Access), etc. Wired Internet technologies may include XDSL (Digital Subscriber Line), FTTH (Fibers to the home), and PLC (Power Line Communication), etc.

Furthermore, in accordance with embodiments of the present disclosure, the network module may include a short-range communication module, which is located relatively close to the player devices. Thus, the player device transmits and receives data to and from an electronic device including the short-range communication module. Bluetooth, RFID (Radio Frequency Identification), Infrared communication (IrDA, Infrared Data Association), UWB (Ultra Wideband), ZigBee, etc. may be used as the short range communication technology.

Example as shown in FIG. 1 illustrates a method for providing a game in accordance with embodiments of the present disclosure. However, the present disclosure is not limited thereto.

The server 100 in accordance with embodiments of the present disclosure will be described. In accordance with embodiments of the present disclosure, the server 100 may be configured to allow matching between the on-line player and the off-line avatar player at least partially based on the first game participation request including off-line avatar player selection from the on-line player. Furthermore, the server 100 may allocate the first authority to the on-line player in a response to the matching between the on-line player and the off-line avatar player. Further, the server 100 may generate an on-line platform to facilitate information communication between the on-line player and the off-line avatar player. The server 100 may allocate the access authority to the on-line platform to the on-line player and the off-line avatar player. In this way, the on-line player 1 and off-line avatar player 3 may exchange various information for executing the game in the off-line region.

In accordance with embodiments of the present disclosure, the server 100 may include a game information generation module 110, a game participation request receiver module 120, a matching module 130, an authority allocation module 140, an on-line platform generation module 150, a controller 160 and a memory 170. The components of the server 100 as shown in FIG. 1 may be exemplary. Thus, the present disclosure is not limited thereto. Hereinafter, the components of the server 100 in accordance with embodiments of the present disclosure will be described in details.

In accordance with embodiments of the present disclosure, the game information generation module 110 may be configured to generate game-related information including at least one of game type, minimum betting amount, information about at least one selectable off-line avatar player, and information about at least one on-line selectable platform, for at least one game held in an off-line region.

In accordance with embodiments of the present disclosure, the game type information refers to types of at least one game held in an off-line region. In this regard, at least one game held in an off-line region may refer to a casino game, For example, at least one game held in an off-line region may refer to roulette, blackjack and/or baccarat. However, the present disclosure is not limited thereto.

In accordance with embodiments of the present disclosure, information about at least one selectable off-line avatar player may indicate off-line avatar players among which the on-line player selects one off-line avatar player. For example, information about at least one selectable off-line avatar player may include gaming available time information for at least one off-line avatar player, fee information for using off-line avatar players, evaluation information about off-line avatar players, and/or wining rate information about the off-line avatar players. However, the present disclosure is not limited thereto.

In accordance with embodiments of the present disclosure, information about at least one on-line selectable platform may include information about the on-line player and off-line avatar player corresponding to the on-line platform. In accordance with embodiments of the present disclosure, information about the on-line platform may include at least one of wining rate information for the game involving the on-line player and the off-line avatar player, gaming-proceeding summary information, and member information about on-line betting participators. However, the present disclosure is not limited thereto.

In accordance with embodiments of the present disclosure, the game participation request receiver module 120 may receive a first game participation request including off-line avatar player selection from the on-line player.

In accordance with embodiments of the present disclosure, the game participation request receiver module 120 may receive a second game participation request including at least one of on-line player selection and on-line platform selection from the on-line betting participator.

Furthermore, in accordance with embodiments of the present disclosure, off-line avatar players involving a game in the off-line region may be graphically expressed and may be sent to the on-line player. In this connection, the game participation request receiver module 120 may receive off-line avatar player selection in a graphically expressed form from the on-line player.

In accordance with embodiments of the present disclosure, the matching module 130 may allow matching between the on-line player and the off-line avatar player at least partially based on the first game participation request. The server 100 may determine whether the on-line player meets a predetermined condition. When the on-line player meets the predetermined condition, the server may allow the matching between the on-line player and the off-line avatar player. When the on-line player does not meet the predetermined condition, the server 100 may generate billing information and, upon the billing payment from the on-line player, the server may determine that the on-line player meet the predetermined condition. This billing information may be sent to the on-line player device 10.

In other words, in accordance with embodiments of the present disclosure, the on-line player should meet the predetermined condition in order to participate in the game executed by the method for providing a game in accordance with embodiments of the present disclosure. The predetermined condition may include, for example, at least one of membership type, game usage history information, payment information, wining rate information, point information, investment amount information and settlement information. For example, any player who purchases a ticket worth $10,000 may participate in the game executed by the method for providing a game in accordance with embodiments of the present disclosure.

In accordance with embodiments of the present disclosure, the on-line betting participator may not meet the predetermined condition. Alternatively, in accordance with embodiments of the present disclosure, when the on-line player does not match the off-line avatar player, the on-line player may act as the on-line betting participator. For example, any player who buys a $5,000 ticket can be determined to be an on-line betting participator. Another example is that any player who buys $10,000 worth of tickets cannot make a selection for an off-line avatar player (due to the absence of an available off-line avatar player) may be determined as an on-line betting participator.

In accordance with embodiments of the present disclosure, the authority allocation module 140 may allocate the first authority to the on-line player in a response to the established matching between the on-line player and the off-line avatar player. In accordance with embodiments of the present disclosure, the first authority may include authorities to receive game-related information from the off-line avatar player and to send gaming-related commands including a betting request to the off-line avatar player.

In accordance with embodiments of the present disclosure, the first authority may be further based on on-line player information about the on-line player. In this regard, the on-line player information may include at least one of player identification information, winning rate information, point information, membership type information, investment amount information and settlement history information. However, the present disclosure is not limited thereto.

In accordance with embodiments of the present disclosure, the first authority may be further based on at least one of a predetermined time, a predetermined number of plays and a predetermined total betting amount. However, the present disclosure is not limited thereto.

For example, in the case of a baccarat game, since the time required for one round of play is very short, the predetermined number of plays is set. In this connection, the matching may be established between the on-line player and the off-line avatar player for the predetermined number of plays. In other words, only for the predetermined number of plays, the on-line player may be allowed to receive game-related information from the matched off-line avatar player, and to transmit gaming-related commands including a betting request to the off-line avatar player,

In accordance with embodiments of the present disclosure, the authority allocation module 140 may be configured to allocate the second authority to the on-line betting participator at least partially based on the second game participation request, wherein the second authority includes authorities to access the on-line platform corresponding to the on-line platform selection, and to make a betting action for the game involving the off-line avatar player and the on-line player.

In accordance with embodiments of the present disclosure, the authority allocation module 140 may be configured to allocate a third authority to the on-line player at least partially based on the second game participation request. In accordance with embodiments of the present disclosure, the third authority may allow transmission of gaming-related commands from the on-line betting participator to the off-line avatar player. Thus, when the on-line player allows the on-line betting participator to send the gaming-related commands to the off-line avatar player, the on-line betting participator may send the gaming-related commands to the off-line avatar player.

In accordance with embodiments of the present disclosure, the on-line platform generation module 150 may be configured to generate an on-line platform to facilitate (information) communication between the on-line player and the off-line avatar player. The on-line platform may be configured to facilitate communication of at least one of the video information, audio information and text information as described above between the on-line player and the off-line avatar player. For example, in accordance with embodiments of the present disclosure, the on-line platform may be embodied as at least one of on-line bulletin platform, on-line chatting platform, on-line messenger platform and on-line voice platform. However, the present disclosure is not limited thereto.

Referring back to the authority allocation module 140, in accordance with embodiments of the present disclosure, in a response to the established between the on-line player 1 and off-line avatar player 3, the authority allocation module 140 may allocate the authority to the on-line player and the off-line avatar player to access the on-line platform to facilitate information communication between the on-line player 1 and off-line avatar player 3.

In accordance with embodiments of the present disclosure, the controller 160 may control and/or control the overall operations including the player's participation in the game, game progression, betting processing and betting settlement.

In accordance with embodiments of the present disclosure, the controller 160 may generate virtual game wherein the game held in an off-line region game is real-time implemented as a graphical virtual game on the online region.

In accordance with embodiments of the present disclosure, the memory 170 may store various information for performing a game in the online area in a corresponding manner to at least one game held in an off-line region. For example, the memory 170 may manage and store therein the players' participation history. For example, game rule information for at least one game may be stored in the memory 170. In accordance with the present disclosure, the memory 170 may store therein predetermined distribution condition for settlement of profit among the on-line player, on-line betting participator, off-line avatar player and game dealer. Furthermore, the memory 170 may store therein membership level information to distinguish between on-line player and on-line betting participator.

In accordance with embodiments of the present disclosure, the memory 170 may store therein the program for the operation of the controller 160, and may temporarily or permanently store therein input/output data, for example, game information, off-line avatar player information, and on-line player information, etc. The memory 170 may store therein video and audio data.

In accordance with embodiments of the present disclosure, the memory 170 may include, but limited thereto, at least one type of storage medium such as flash type memory, hard disk type memory, multimedia card micro type memory, card type memory (for example, SD or XD memory), RAM (Random Access Memory), SRAM (Static Random Access), ROM (Read only Memory), EEPROM (electrically erasable programmable read-only memory), PROM (programmable read-only memory), magnetic memory, magnetic disk, or optical disc.

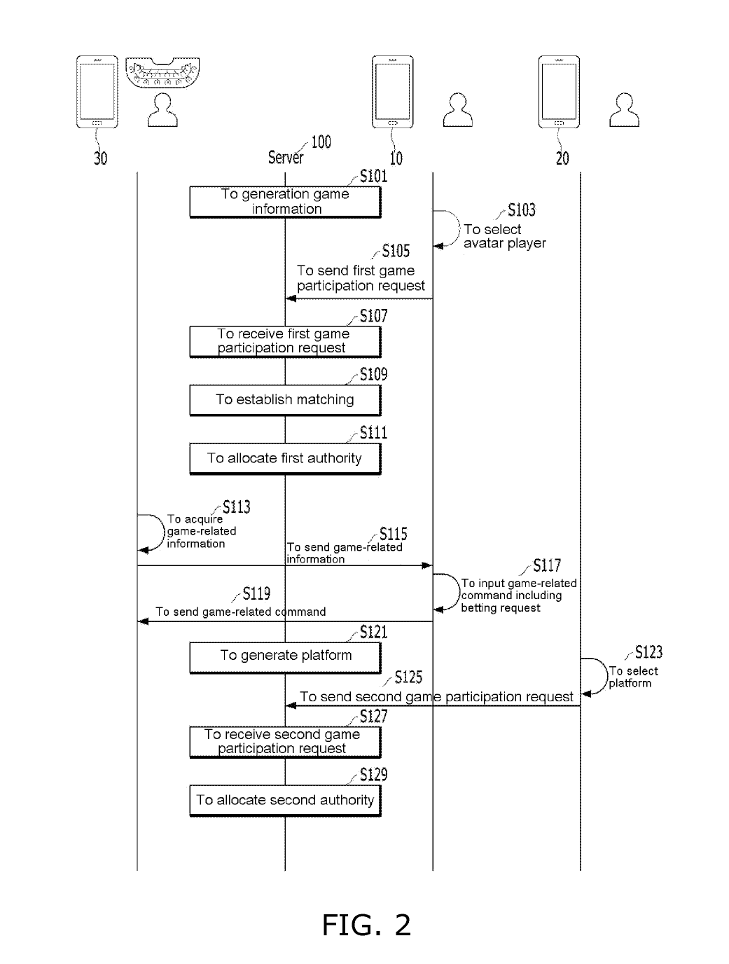

In accordance with embodiments of the present disclosure, the memory 170 may store therein various information, rules, and commands to provide the game. Those various information, rules, and instructions will be described later with reference to FIG. 2 to FIG. 4.

In accordance with embodiments of the present disclosure, the memory 170 may store therein programs, software, instructions, codes, etc. that execute the server 100 and/or player devices 10, 20 and 30. In accordance with embodiments of the present disclosure, the memory 170 may temporarily store therein data including the cache, and temporarily store therein programs and instructions necessary for operating the server 100 and/or player devices 10, 20 and 30.

In accordance with embodiments of the present disclosure, the memory 170 may embodied as one or more non-transitory, computer-readable media having instructions stored thereon, and the controller 160 may be embodied as one or more processors.

In this connection, in accordance with embodiments of the present disclosure, the instructions when executed by the one or more processors may cause the one or more processors to perform operations of a method for providing a game, wherein the operations includes: receiving a first game participation request including off-line avatar player selection from an on-line player device 10, wherein the off-line avatar player is preset in an off-line game region and plays the game, wherein the on-line player device 10 is of an on-line player who is not present in the off-line game region but in on-line game region and plays the game, wherein the off-line avatar player has an off-line avatar player device 30; establishing matching between the on-line player 1 and the off-line avatar player 3 at least partially based on the first game participation request; in a response to the established matching between the on-line player and the off-line avatar player, allocating a first authority to the on-line player device 10, wherein the first authority allows the on-line player device to receive game-related information from the off-line avatar player device 30 and to send gaming-related commands including a betting request to the off-line avatar player device; in a response to the established matching between the on-line player and the off-line avatar player, allocating an access authority to the on-line player device 10 and the off-line avatar player device 30 to access an on-line platform to facilitate communication between the on-line player device and the off-line avatar player device; receiving a second game participation request including at least one of on-line player selection and on-line platform selection from an on-line betting participator device 20, wherein the on-line betting participator device is of an on-line betting participator who is not present in the off-line game region but in on-line game region and make a betting action for the game involving the on-line player and off-line avatar player; and allocating a second authority to the on-line betting participator device 20 at least partially based on the second game participation request, wherein the second authority includes authorities to allow the on-line betting participator device to access the on-line platform corresponding to the on-line platform selection, and to make a betting action for the game involving the on-line player and off-line avatar player.

In accordance with embodiments of the present disclosure, the server 100 may include a network module. The network module may include wired/wireless Internet modules for network access. Wireless Internet techniques may include WLAN (wireless LAN: Wi-Fi), Wibro (wireless broadband), Wimax (World Interoperability for Microwave Access), HSDPA (High Speed Downlink Packet Access), etc. Wired Internet technologies may include XDSL (Digital Subscriber Line), FTTH (Fibers to the home), and PLC (Power Line Communication), etc.

Furthermore, in accordance with embodiments of the present disclosure, the network module may include a short-range communication module, which is located relatively close to the player devices. Thus, the player device transmits and receives data to and from an electronic device including the short-range communication module. Bluetooth, RFID (Radio Frequency Identification), Infrared communication (IrDA, Infrared Data Association), UWB (Ultra Wideband), ZigBee, etc. may be used as the short range communication technology.

In accordance with embodiments of the present disclosure, the network module can detect the connection state of the network and the communication speed of the network. Data received via the network module may be sent to the devices 10, 20 and 30 and may then be output through the display of each of the player devices 10, 20 and 30. Data received via the network module may be stored in the memory 170, or may be transmitted to other electronic devices in the vicinity via a local communication module.

In accordance with an embodiment of the present disclosure, the server 100 may include only of some of the components described above. The server 100 may be in association and communication with external server. Alternatively, the server 100 may be independent. Moreover, some of the components of the server 100 described above may be integrated into a single component. For example, portions of the matching module 130, the authority allocation module 140, and the on-line platform generation module 150 may be integrated into the controller 160.

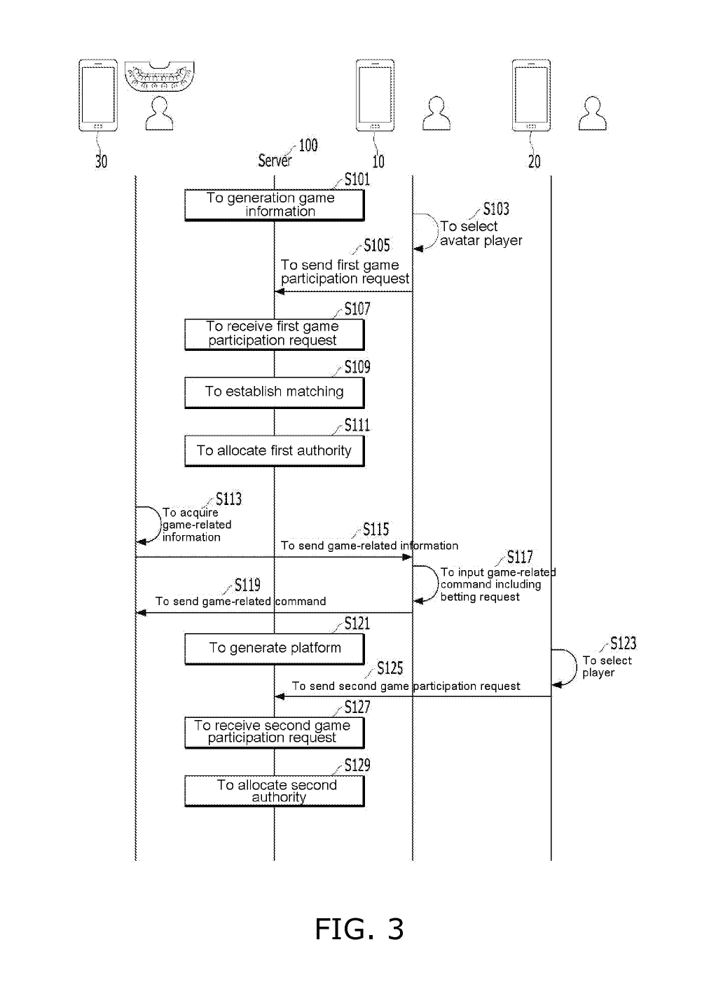

FIG. 2 is a flow chart of a method for providing a game in accordance with embodiments of the present disclosure. FIG. 3 is another flow chart of a method for providing a casino game in accordance with embodiments of the present disclosure.

Referring to FIG. 2 and FIG. 3, illustrated operations of an example method for providing a game may be exemplary. Thus, the order of the operations may be changed and/or some of the operations may be integrated. Further, additional operations other than the operations shown can be implemented herein.

Although not shown in FIG. 2 and FIG. 3, a player who wishes to participate in the game implemented by the method for providing a game in accordance with embodiments of the present disclosure may be connected to the server 100 connected to the network using a web browser and/or application. The server 100 may receive a player Identification and/or password and search the memory 180 through an execution script to check whether the player is an existing registered member. If the player is an existing registered member, he/she is permitted to participate in the game implemented by the method for providing a game in accordance with embodiments of the present disclosure using the player information.

The player as a member is given an authority to participate in the game by the server 100. This authority may be different according to the player information. In accordance with embodiments of the present disclosure, the authority to participate in the game may vary depending on a level of membership, an amount of payment, a type of membership, a type of ticket, an acquired point, or an acquired item, etc.

Hereinafter, with reference to FIG. 2, the method for providing a game in accordance with embodiments of the present disclosure will be described in details. In this connection, the same description will be omitted as described above with reference to FIG. 1.

In accordance with embodiments of the present disclosure, the server 100 may generate game information S101. The generated game information may be transmitted to the on-line player device 10, the on-line betting participator device 20, and the off-line avatar player device 30. An avatar player selection input from the on-line player device 1 may be received at the server 100. In this connection, the on-line player device 10 may send the first game participation request including the avatar player selection to the server 100 S105.

In accordance with embodiments of the present disclosure, the server 100 may receive the first game participation request S107. The server 100 may establish matching between the on-line player and the off-line avatar player at least partially based on the first game participation request. Then, in a response to the established matching between the on-line player and the off-line avatar player, the server 100 may allocate a first authority to the on-line player device, wherein the first authority allows the on-line player device to receive game-related information from the off-line avatar player device and to send gaming-related commands including a betting request to the off-line avatar player device.

Meanwhile, game-related information may be obtained from the off-line avatar player device 30 of the matched off-line avatar player 3 with the on-line player 1 S113. In this regard, the game-related information may include at least one of video information and audio information about at least one game held one off-line region. For example, the game-related information may refer to the video and audio of the casino game scene obtained from the off-line avatar player device 30. However, the present disclosure is not limited.

Through operation S107 to operation S111, related information communication may be allowed between the on-line player device and the off-line avatar player device. The related information may include the game-related information obtained from the off-line avatar player, and game-related commands including a betting request, and so on. Accordingly, the game-related information obtained through operation S113 can be transmitted to the on-line player device 10 at S115.

The first player 1 may input, using the on-line player device 10, the gaming-related commands including a betting request information to the off-line avatar player device S117, wherein the betting request information includes betting command and amount executed by the off-line avatar player 3 in the off-line gaming area. In accordance with embodiments of the present disclosure, the on-line player device 10 may send the gaming-related commands including the betting request information to the off-line avatar player device 30 S119.

In addition, in accordance with embodiments of the present disclosure, in a response to the established matching between the on-line player and the off-line avatar player, the server 100 may generate an on-line platform to facilitate communication between the on-line player device 10 and the off-line avatar player device 30 S121. In this connection, the server may allocate an access authority to the on-line player device and the off-line avatar player device to access the on-line platform to facilitate communication between the on-line player device and the off-line avatar player device.

In accordance with embodiments of the present disclosure, the on-line platform may be configured to facilitate communication of at least one of video information, audio information and text information. In one embodiment, the on-line platform may be embodied as at least one of on-line bulletin platform, on-line chatting platform, on-line messenger platform and on-line voice platform.

The server 100 may receive the second game participation request including at least one of on-line player selection and on-line platform selection from the on-line betting participator device 20 S123.

Referring to FIG. 2, in accordance with embodiments of the present disclosure, the second game participation request including the on-line platform selection from the on-line betting participator 2 may be sent to the server 100.

Referring to FIG. 3, in accordance with embodiments of the present disclosure, the second game participation request including the on-line player selection from the on-line betting participator 2 may be sent to the server 100. That is, the FIG. 2 and FIG. 3 are different in that in FIG. 2, the on-line platform selection is sent to the server while in FIG. 3, the on-line player selection is sent to the server.

The server 100 may receive the second game participation request S127. The server 100 may allocate the second authority to the on-line betting participator S129. That is, in accordance with embodiments of the present disclosure, the server 100 may allocate the second authority to the on-line betting participator device 20 at least partially based on the second game participation request, wherein the second authority includes authorities to allow the on-line betting participator device 30 to access the on-line platform corresponding to the on-line platform selection, and to make a betting action for the game involving the on-line player and off-line avatar player.

The method for providing the game in accordance with the embodiments of the present disclosure may be applied to, for example, baccarat game. This baccarat game is played using cards based on the game rules set at the casino site. The baccarat has a simple gaming rule and thus does not require a strategy or an option like another casino game. When the card are drawn, the game automatically progresses according to a certain rule regardless of whether the betting is carried out by the player or the banker. In the baccarat game, one play takes about one minute, so that a rapid progress can be made.

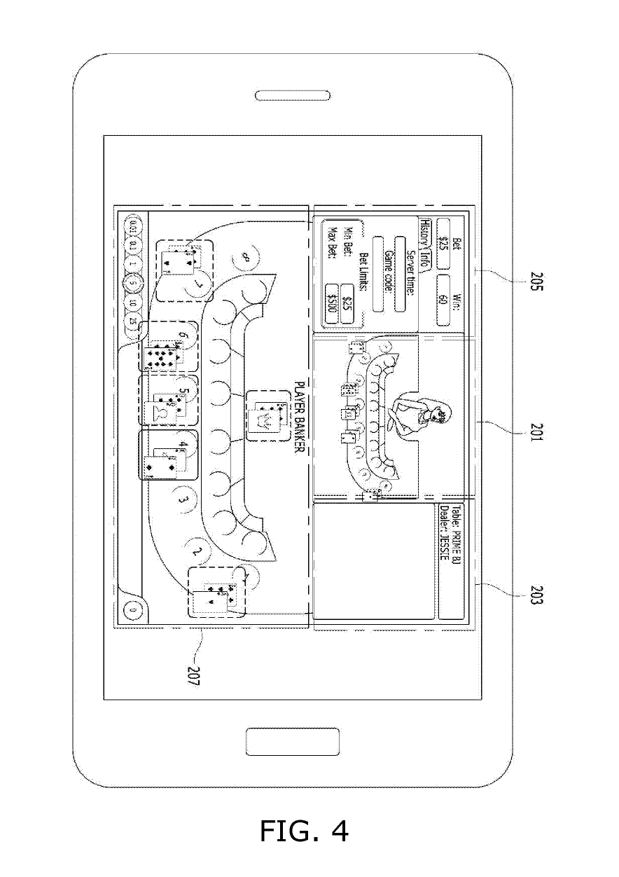

FIG. 4 is a view of an example of a use interface of the player device during the gaming using the method for providing a game in accordance with embodiments of the present disclosure.

In accordance with embodiments of the present disclosure, in a response to the established matching between the on-line player and the off-line avatar player, the server may allocate the access authority to the on-line player device and the off-line avatar player device to access the on-line platform to facilitate communication between the on-line player device and the off-line avatar player device;

In accordance with embodiments of the present disclosure second, the server may allocate the second authority to the on-line betting participator device at least partially based on the second game participation request, wherein the second authority includes authorities to allow the on-line betting participator device to access the on-line platform corresponding to the on-line platform selection, and to make a betting action for the game involving the on-line player and off-line avatar player.

FIG. 4 may be a view of an example of a use interface of the player device 10, that is, the on-line player device 10 during the gaming using the method for providing a game in accordance with embodiments of the present disclosure. Specifically, the use interface of the player device 10, that is, the on-line player device 10 may act as the on-line platform.

Although the use interface of the player device as shown in FIG. 4 is of the on-line player device 10, the present disclosure is not limited thereto. For example, the use interface of the player device as shown in FIG. 4 is applied to the on-line betting participator device 20 as the on-line platform.

In accordance with embodiments of the present disclosure, the game-related information acquired from the off-line avatar player device 10 may include at least one of video information and audio information related to at least one game held in the off-line region. However, the present disclosure is not limited thereto.

Game-related information, as described above, may be the real time video 201 and 207 showing the progress of, for example, the casino game held in the off-line region. For example, the game progress video shown in, for example, 201 and 207 may be obtained from the off-line avatar player device 10 in accordance with an embodiment of the present disclosure.

To assist in the participation of the on-line player and on-line betting participator, information obtained from another device installed on the casino table may be presented from the user interface. In accordance with embodiments of the present disclosure, a video game implemented as a graphical and animated virtual game in connection with the progress of the casino game may be presented from portions 201 and 207 of the user interface.

In accordance with embodiments of the present disclosure, the on-line platform as shown in FIG. 4 may be configured to facilitate communication of at least one of video information, audio information and text information. Further, the on-line platform may be embodied as at least one of on-line bulletin platform, on-line chatting platform, on-line messenger platform and on-line voice platform.

In FIG. 4, the user interface including a chat on-line platform 203 is shown. Furthermore, the game information may be graphically displayed 205 so that the game progress information can be intuitively confirmed.

In accordance with embodiments of the present disclosure, the user interface as shown in FIG. 4 may present the information about at least one selectable off-line avatar player such as at least one of gaming available time for at least one off-line avatar player, fee information for using off-line avatar players, evaluation information about off-line avatar players, and/or wining rate information about off-line avatar players. Further, In accordance with embodiments of the present disclosure, the user interface as shown in FIG. 4 may present the information about the on-line platform such as at least one of wining rate information for the game involving the on-line player and the off-line avatar player, gaming-proceeding summary information about the game, and member information about on-line betting participators for the game.

The user interface as shown in FIG. 4 may be merely one example and thus the present disclosure is not limited thereto. The user interface as shown in FIG. 4 indicates various types, names, functions and shapes in accordance with embodiments of the present disclosure. However, the various types, names, functions and shapes merely examples and thus the present disclosure is not limited thereto.

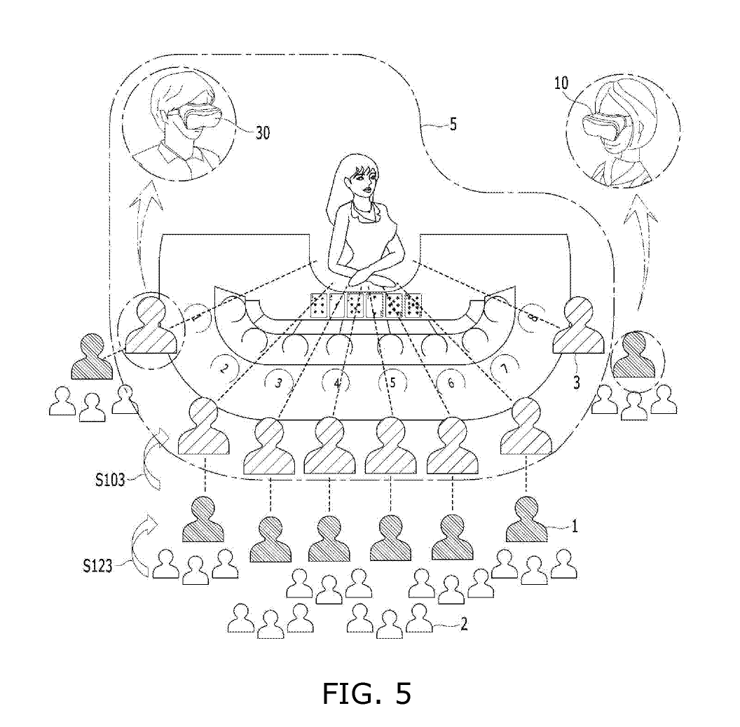

FIG. 5 is a conceptional view for describing a method for providing a game in accordance with embodiments of the present disclosure. FIG. 5 is a conceptional view for describing a method for providing a game in accordance with the embodiments of the present disclosure as described above with reference to FIG. 1 to FIG. 4.

In FIG. 5, there are shown the off-line avatar player device 30 carried by the off-line avatar player 3, the on-line player device 10 carried by the on-line player 1, and the on-line betting participator device 20 carried by the on-line betting participator 2.

In accordance with embodiments of the present disclosure, the off-line avatar player 3 may execute the game in the off-line region 5 using the method for providing a game in accordance with an embodiment of the present disclosure. This off-line avatar player 3 may receive the gaming-related commands from the on-line player 1 and/or on-line betting participator 2 via the off-line avatar player device 30 over the communication network and server 100. Thus, the off-line avatar player 3 may execute the game based on the gaming-related commands. The on-line player 1 and/or on-line betting participator 2 may not be located in the off-line area 5 where the off-line game proceeds. However, the on-line player 1 and/or on-line betting participator 2 may participate in the game by inputting the gaming-related commands to the line avatar player using the method for providing a game in accordance with the embodiments of the present disclosure.

The on-line player 1 and/or on-line betting participator 2, which is not located in the off-line zone 5 may receive the game proceeding scene from the through the off-line avatar player 3 located in the off-line zone 5. Then, the on-line player 1 and/or on-line betting participator 2 may participate in the gaming continuing in the zone 5.

Therefore, in accordance with the present disclosure, the user located far from the off-line game zone may participate in the game in on-line manner.

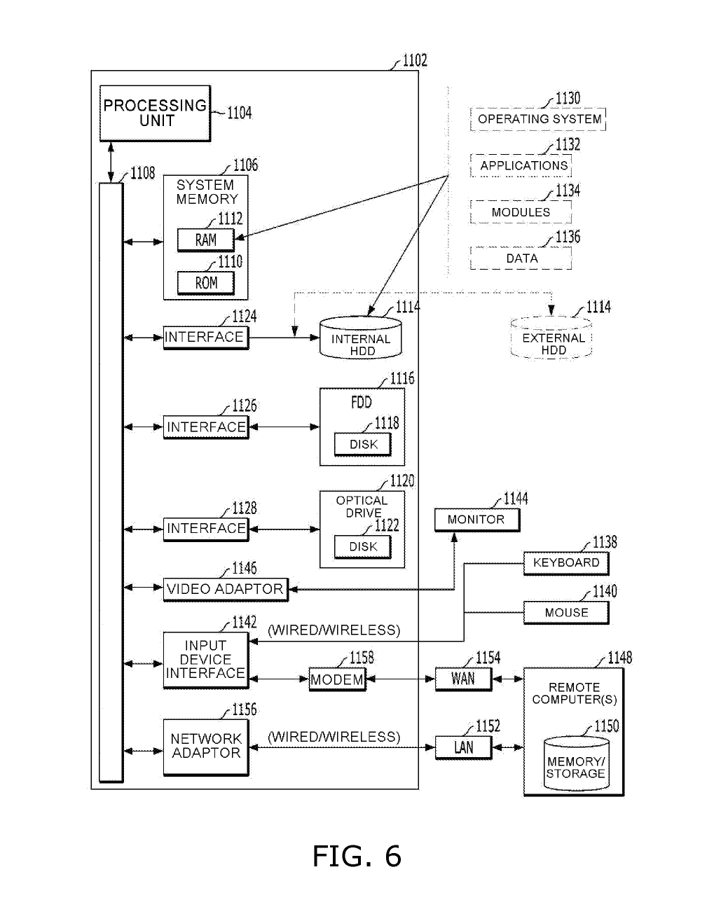

FIG. 6 is a block diagram of a computer executing a computer program configured to execute a method for providing a game in accordance with embodiments of the present disclosure.

Referring to FIG. 6, a brief general description of a suitable computing environment in which various aspects of the embodiments of the present disclosure may be implemented may be provided.

Although the present disclosure has been described above generally in terms of computer-executable instructions that may be executed on an at least one computer, those skilled in the art will appreciate that the disclosure may be embodied in combination with other program modules and/or in a combination of hardware and software.

Generally, program modules include routines, programs, components, data structures, etc. that perform particular tasks or implement particular abstract data types. Moreover, those skilled in the art will appreciate that the methods of the present invention can be implemented with another computer system configuration, including a single-processor or multiprocessor computer system, a minicomputer, a mainframe computer as well as a personal computer, a handheld computing device, a microprocessor-based or programmable consumer electronics. In this connection, those another computer system may operate in connection with at least one associated device.

A computer typically includes a variety of computer-readable media. Computer-readable media can be any available media that can be accessed by the computer and includes both volatile and non-volatile media, removable and non-removable media. By way of example, and not limitation, computer-readable media can comprise computer storage media and communication media. Computer storage media includes both volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically includes all information delivery media by applying computer readable instructions, data structures, program modules or other data to a modulated data signal, such as a carrier wave or other transport mechanism. The term modulated data signal refers to a signal that sets or changes one or more of the characteristics of the signal to encode information in the signal. By way of example, and not limitation, communication media includes wired media such as a wired network or direct-wired connection, and wireless media such as audio, RF, infrared, and other wireless media. Combination of any of the above-mentioned media may be also included within the scope of computer-readable medium.

With reference again to FIG. 6, the exemplary computing environment for implementing various aspects includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures may also be employed as the processing unit 1104.

The system bus 1108 can be any of several types of bus structure that may further interconnect to a memory bus (with or without a memory controller), a peripheral bus, and a local bus using any of a variety of commercially available bus architectures. The system memory 1106 includes read-only memory (ROM) 1110 and random access memory (RAM) 1112. A basic input/output system (BIOS) is stored in a non-volatile memory 1110 such as ROM, EPROM, EEPROM, which BIOS contains the basic routines that help to transfer information between elements within the computer 1102, such as during start-up. The RAM 1112 can also include a high-speed RAM such as static RAM for caching data.

The computer 1102 further includes an internal hard disk drive (HDD) 1114 (e.g., EIDE, SATA), which internal hard disk drive 1114 may also be configured for external use in a suitable chassis (not shown), a magnetic floppy disk drive (FDD) 1116, (e.g., to read from or write to a removable diskette 1118) and an optical disk drive 1120, (e.g., reading a CD-ROM disk 1122 or, to read from or write to other high capacity optical media such as the DVD). The hard disk drive 1114, magnetic disk drive 1116 and optical disk drive 1120 can be connected to the system bus 1108 by a hard disk drive interface 1124, a magnetic disk drive interface 1126 and an optical drive interface 1128, respectively. The interface 1124 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 1102, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the disclosed innovation.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. It is to be appreciated that the innovation can be implemented with various commercially available operating systems or combinations of operating systems.

A user can enter commands and information into the computer 1102 through one or more wired/wireless input devices, e.g., a keyboard 1138 and a pointing device, such as a mouse 1140. Other input devices (not shown) may include a microphone, an IR remote control, a joystick, a game pad, a stylus pen, touch screen, or the like. These and other input devices are often connected to the processing unit 1104 through an input device interface 1142 that is coupled to the system bus 1108, but can be connected by other interfaces, such as a parallel port, an IEEE 1394 serial port, a game port, a USB port, an IR interface, etc.

A monitor 1144 or other type of display device is also connected to the system bus 1108 via an interface, such as a video adapter 1146. In addition to the monitor 1144, a computer typically includes other peripheral output devices (not shown), such as speakers, printers, etc. The computer 1102 may operate in a networked environment using logical connections via wired and/or wireless communications to one or more remote computers, such as a remote computer(s) 1148. The remote computer(s) 1148 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1150 is illustrated. The logical connections depicted include wired/wireless connectivity to a local area network (LAN) 1152 and/or larger networks, e.g., a wide area network (WAN) 1154. Such LAN and WAN networking environments are commonplace in offices and companies, and facilitate enterprise-wide computer networks, such as intranets, all of which may connect to a global communications network, e.g., the Internet.

When used in a LAN networking environment, the computer 1102 is connected to the local network 1152 through a wired and/or wireless communication network interface or adapter 1156. The adaptor 1156 may facilitate wired or wireless communication to the LAN 1152, which may also include a wireless access point disposed thereon for communicating with the wireless adaptor 1156.

When used in a WAN networking environment, the computer 1102 can include a modem 1158, or is connected to a communications server on the WAN 1154, or has other means for establishing communications over the WAN 1154, such as by way of the Internet. The modem 1158, which can be internal or external and a wired or wireless device, is connected to the system bus 1108 via the serial port interface 1142. In a networked environment, program modules depicted relative to the computer 1102, or portions thereof, can be stored in the remote memory/storage device 1150. It will be appreciated that the network connections shown are exemplary and other means of establishing a communications link between the computers can be used.

The computer 1102 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11x (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks can operate in the unlicensed 2.4 and 5 GHz radio bands. IEEE 802.11 applies to generally to wireless LANs and provides 1 or 2 Mbps transmission in the 2.4 GHz band using either frequency hopping spread spectrum (FHSS) or direct sequence spread spectrum (DSSS). IEEE 802.11a is an extension to IEEE 802.11 that applies to wireless LANs and provides up to 54 Mbps in the 5 GHz band. IEEE 802.11a uses an orthogonal frequency division multiplexing (OFDM) encoding scheme rather than FHSS or DSSS. IEEE 802.11b (also referred to as 802.11 High Rate DSSS or Wi-Fi) is an extension to 802.11 that applies to wireless LANs and provides 11 Mbps transmission (with a fallback to 5.5, 2 and 1 Mbps) in the 2.4 GHz band. IEEE 802.11g applies to wireless LANs and provides 20+Mbps in the 2.4 GHz band. Products can contain more than one band (e.g., dual band), so the networks can provide real-world performance similar to the basic 10 BaseT wired Ethernet networks used in many offices.

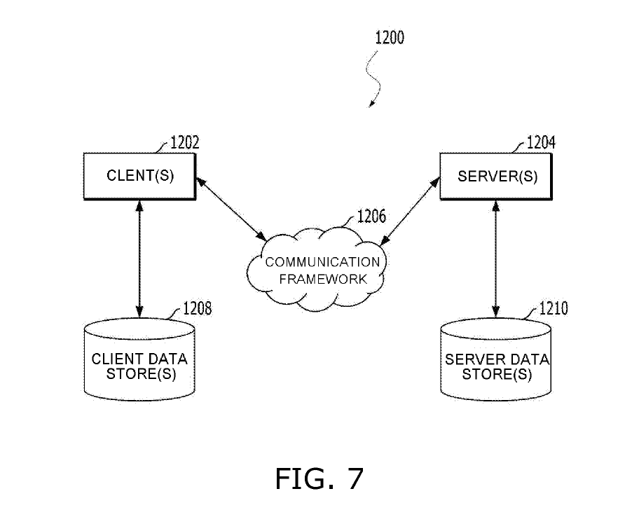

FIG. 7 illustrates a schematic block diagram of an exemplary computing environment operable to perform a method for providing a game in accordance with the present disclosure.

Referring now to FIG. 7, there is illustrated a schematic block diagram of an exemplary computing environment 1200 operable a method for providing a game in accordance with the present disclosure. The system 1200 includes one or more client(s) 1202. The client(s) 1202 can be hardware and/or software (e.g., threads, processes, computing devices). The client(s) 1202 can house cookie(s) and/or associated contextual information by employing the subject innovation, for example.

The system 1200 also includes one or more server(s) 1204. The server(s) 1204 can also be hardware and/or software (e.g., threads, processes, computing devices). The servers 1204 can house threads to perform transformations by employing the invention, for example. One possible communication between a client 1202 and a server 1204 can be in the form of a data packet adapted to be transmitted between two or more computer processes. The data packet may include a cookie and/or associated contextual information, for example.

The system 1200 includes a communication framework 1206 (e.g., a global communication network such as the Internet) that can be employed to facilitate communications between the client(s) 1202 and the server(s) 1204.

Communications can be facilitated via a wired (including optical fiber) and/or wireless technology. The client(s) 1202 are operatively connected to one or more client data store(s) 1208 that can be employed to store information local to the client(s) 1202 (e.g., cookie(s) and/or associated contextual information). Similarly, the server(s) 1204 are operatively connected to one or more server data store(s) 1210 that can be employed to store information local to the servers 1204.

What has been described above includes examples of the disclosed innovation. It is, of course, not possible to describe every conceivable combination of components and/or methodologies, but one of ordinary skill in the art may recognize that many further combinations and permutations are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

Those skilled in the art may understand that information and signals may be expressed using various arbitrary technologies and techniques. For example, data, instructions, commands, information, signals, bits, symbols, and chips which may be referred in the above description may be expressed by voltages, currents, electromagnetic waves, magnetic fields, or particles, optical fields, or particles, or an arbitrary combination thereof.

Those skilled in the art may understand that various exemplary logic blocks, modules, processors, means, circuits, and algorithm steps described with reference to the exemplary embodiments disclosed herein may be implemented by being combined with electronic hardware, various types of programs (here, referred to as software for the purpose of convenience) or a design code or a combination thereof. In order to clearly describe the compatibility of the hardware and the software, various exemplary components, blocks, modules, circuits, and steps are generally described above with respect to functions thereof. Whether the function is implemented as the hardware or software depends on design restrictions which are assigned to a specific application and an entire system. Those skilled in the art may implement the described function of a specific application by various methods but decision of the implement needs to be interpreted that it does not depart from the scope of the present invention.

Various exemplary embodiments suggested herein may be implemented by articles manufactured using a method, an apparatus, or a standard programming and/or engineering technology. A terminology of “manufactured article” includes a computer program, a carrier, or a medium which is accessed from an arbitrary computer readable device. For example, the computer readable medium includes a magnetic storing device (for example, a hard disk, a floppy disk, or a magnetic strip), an optical disk (for example, CD or DVD), a smart card, and a flash memory device (for example, an EEPROM, a card, a stick, and a key drive), but is not limited thereto. Further, various storage media suggested herein include one or more devices for storing information and/or other machine readable media. A terminology of “machine readable medium” includes a wireless channel which stores, holds, and/or transmits commands and/or data and various other media, but are not limited thereto.

It should be understood that a specific order or a hierarchical structure of steps in suggested processes are examples of exemplary approaches. It should be understood that a specific order or a hierarchical structure of steps in processes may be rearranged based on a design priority within the scope of the present invention. Accompanying method claims provide elements of various steps in the order of samples, but are not limited to the suggested specific order or hierarchical structure.

Description of the suggested exemplary embodiments is provided so that those skilled in the art use or carry out the present invention. Various modifications of the exemplary embodiment are obvious to those skilled in the art and general principles defined herein may be applied to other exemplary embodiments without departing from the scope of the present invention. Therefore, the present invention is not limited to the suggested exemplary embodiment, but interpreted in the broadest scope consistent with the principles suggested herein and new features.

What is claimed is:

1. One or more non-transitory, computer-readable media having instructions stored thereon, the instructions when executed by one or more processors cause the one or more processors to perform operations of a method for providing a game, wherein the operations includes:
receiving a first game participation request including off-line avatar player selection from an on-line player device, wherein the off-line avatar player is preset in an off-line game region and plays the game, wherein the on-line player device is of an on-line player who is not present in the off-line game region but in on-line game region and plays the game, wherein the off-line avatar player has an off-line avatar player device;
establishing matching between the on-line player and the off-line avatar player at least partially based on the first game participation request;
in a response to the established matching between the on-line player and the off-line avatar player, allocating a first authority to the on-line player device, wherein the first authority allows the on-line player device to receive game-related information from the off-line avatar player device and to send gaming-related commands including a betting request to the off-line avatar player device;
in a response to the established matching between the on-line player and the off-line avatar player, allocating an access authority to the on-line player device and the off-line avatar player device to access an on-line platform to facilitate communication between the on-line player device and the off-line avatar player device;
receiving a second game participation request including at least one of on-line player selection and on-line platform selection from an on-line betting participator device, wherein the on-line betting participator device is of an on-line betting participator who is not present in the off-line game region but in on-line game region and make a betting action for the game involving the on-line player and off-line avatar player; and
allocating a second authority to the on-line betting participator device at least partially based on the second game participation request, wherein the second authority includes authorities to allow the on-line betting participator device to access the on-line platform corresponding to the on-line platform selection, and to make a betting action for the game involving the on-line player and off-line avatar player.

2. The one or more non-transitory, computer-readable media of claim 1, wherein the operations further includes:
generating game-related information including at least one of game type, minimum betting amount, information about at least one selectable off-line avatar player, and information about at least one on-line selectable platform, for the game held in the off-line region.

3. The one or more non-transitory, computer-readable media of claim 1, wherein the operations further includes:
generating graphical representation of the off-line avatar player involving the game in the off-line region,
wherein the off-line avatar player selection comprises selection of the graphically represented off-line avatar player from the on-line player device.

4. The one or more non-transitory, computer-readable media of claim 1, wherein the operations further includes:
determining whether the on-line player meets a predetermined condition,
wherein the operation of establishing matching between the on-line player and the off-line avatar player includes:
upon determination that the on-line player meets the predetermined condition, establishing matching between the on-line player and the off-line avatar player; and
upon determination that the on-line player does meet the predetermined condition, generating billing information, wherein when the on-line player has paid for the billing, it is determined that the on-line player meets the predetermined condition.

5. The one or more non-transitory, computer-readable media of claim 1, wherein the operations further includes:
allocating a third authority to the on-line player device at least partially based on the second game participation request, wherein the third authority allow transmissions of gaming-related commands from the on-line betting participator device to the off-line avatar player device.

6. The one or more non-transitory, computer-readable media of claim 1, wherein the first authority is allocated based on at least one of a predetermined time, a predetermined number of plays of the game, and a predetermined total betting amount.

7. The one or more non-transitory, computer-readable media of claim 1, wherein the first authority is further based on on-line player information about the on-line player, wherein the on-line player information includes at least one of player identification information, winning rate information, point information, membership type information, investment amount information and settlement history information.

8. The one or more non-transitory, computer-readable media of claim 1, wherein the on-line platform is configured to facilitate communication of at least one of video information, audio information and text information, wherein the on-line platform is embodied as at least one of on-line bulletin platform, on-line chatting platform, on-line messenger platform and on-line voice platform.

9. The one or more non-transitory, computer-readable media of claim 1, wherein the game-related information is acquired by the off-line avatar player device, wherein the game-related information includes at least one of video information and audio information for the game held the off-line region.

10. The one or more non-transitory, computer-readable media of claim 1, wherein the game held the off-line region includes at least one of roulette, blackjack or baccarat.

11. The one or more non-transitory, computer-readable media of claim 2, wherein the information about at least one selectable off-line avatar player includes at least one of gaming available time for at least one off-line avatar player, fee information for using off-line avatar players, evaluation information about off-line avatar players, and/or wining rate information about off-line avatar players,
wherein the information about the on-line platform includes at least one of wining rate information for the game involving the on-line player and the off-line avatar player, gaming-proceeding summary information about the game, and member information about on-line betting participators for the game.

12. A server for providing a game,
wherein the server are communicatively coupled to an on-line player device, an off-line avatar player device, and an on-line betting participator device, wherein the on-line player device, the off-line avatar player device, and the on-line betting participator device are of an on-line player, an off-line avatar player, and an on-line betting participator respectively, wherein the off-line avatar player is preset in an off-line game region and plays the game, wherein the on-line player is not present in the off-line game region but in on-line game region and plays the game, wherein the on-line betting participator is not present in the off-line game region but in on-line game region and makes a betting action for the game involving the on-line player and off-line avatar player,
wherein the server comprises:
means for receiving a first game participation request including off-line avatar player selection from the on-line player device;
means for establishing matching between the on-line player and the off-line avatar player at least partially based on the first game participation request;
in a response to the established matching between the on-line player and the off-line avatar player, means for allocating a first authority to the on-line player device, wherein the first authority allows the on-line player device to receive game-related information from the off-line avatar player device and to send gaming-related commands including a betting request to the off-line avatar player device;
in a response to the established matching between the on-line player and the off-line avatar player, means for allocating an access authority to the on-line player device and the off-line avatar player device to access an on-line platform to facilitate communication between the on-line player device and the off-line avatar player device;
means for receiving a second game participation request including at least one of on-line player selection and on-line platform selection from the on-line betting participator device; and
means for allocating a second authority to the on-line betting participator device at least partially based on the second game participation request, wherein the second authority includes authorities to allow the on-line betting participator device to access the on-line platform corresponding to the on-line platform selection, and to make a betting action for the game involving the on-line player and off-line avatar player.

13. A system for providing a game, system including a server, an on-line player device, and an off-line avatar player device, wherein the sever and devices are communicatively coupled to each other, wherein the on-line player device, and the off-line avatar player device are of an on-line player, and an off-line avatar player, wherein the off-line avatar player is preset in an off-line game region and plays the game, wherein the on-line player is not present in the off-line game region but in on-line game region and plays the game, wherein the server comprises:
means for receiving a first game participation request including off-line avatar player selection from the on-line player device;
means for establishing matching between the on-line player and the off-line avatar player at least partially based on the first game participation request;
in a response to the established matching between the on-line player and the off-line avatar player, means for allocating a first authority to the on-line player device, wherein the first authority allows the on-line player device to receive game-related information from the off-line avatar player device and to send gaming-related commands including a betting request to the off-line avatar player device; and
in a response to the established matching between the on-line player and the off-line avatar player, means for allocating an access authority to the on-line player device and the off-line avatar player device to access an on-line platform to facilitate communication between the on-line player device and the off-line avatar player device.

14. The system of claim 13, wherein the system further include an on-line betting participator device, wherein the on-line betting participator device is of an on-line betting participator, wherein the on-line betting participator is not present in the off-line game region but in on-line game region and makes a betting action for the game involving the on-line player and off-line avatar player,
wherein the server further comprises:
means for receiving a second game participation request including at least one of on-line player selection and on-line platform selection from the on-line betting participator device; and
means for allocating a second authority to the on-line betting participator device at least partially based on the second game participation request, wherein the second authority includes authorities to allow the on-line betting participator device to access the on-line platform corresponding to the on-line platform selection, and to make a betting action for the game involving the on-line player and off-line avatar player.

15. The system of claim 13, wherein the server further comprises:
means for generating game-related information including at least one of game type, minimum betting amount, information about at least one selectable off-line avatar player, and information about at least one on-line selectable platform, for the game held in the off-line region.

16. The system of claim 13, wherein the server further comprises:
means for determining whether the on-line player meets a predetermined condition,
wherein the means for establishing matching between the on-line player and the off-line avatar player includes:
upon determination that the on-line player meets the predetermined condition, means for establishing matching between the on-line player and the off-line avatar player; and
upon determination that the on-line player does meet the predetermined condition, means for generating billing information, wherein when the on-line player has paid for the billing, it is determined that the on-line player meets the predetermined condition.

17. The system of claim 14, wherein the server further comprises:
means for allocating a third authority to the on-line player device at least partially based on the second game participation request, wherein the third authority allow transmissions of gaming-related commands from the on-line betting participator device to the off-line avatar player device.

18. The system of claim 13, wherein the first authority is allocated based on at least one of a predetermined time, a predetermined number of plays of the game, and a predetermined total betting amount.

19. The system of claim 13, wherein the first authority is further based on on-line player information about the on-line player, wherein the on-line player information includes at least one of player identification information, winning rate information, point information, membership type information, investment amount information and settlement history information.

20. The system of claim 13, wherein the on-line player device and/or the off-line avatar player is embodied as a VR (virtual reality) device and/or 3D (three-dimensional) device.
